(19) United States
(12) Patent Application Publication
(10) Pub. No.: US 2002/0062245 A1
(43) Pub. Date: May 23, 2002

(54) System and method for generating real-time promotions on an electronic commerce world wide website to increase the likelihood of purchase

(76) Inventors: David Niu, Seattle, WA (US); Andrew I Liu, Seattle, WA (US); Edward Chang, Philadelphia, PA (US)

Correspondence Address: CONNOLLY BOVE LODGE & HUTZ, LLP, 1220 N MARKET STREET, P O BOX 2207, WILMINGTON, DE, 19899

(21) Appl. No.: 09/801,129

(22) Filed: Mar. 7, 2001

Related U.S. Application Data
(60) Provisional application No. 60/188,351, filed on Mar. 9, 2000.

(51) Int. Cl. G06F 17/60

(52) U.S. Cl. 705/14; 705/10

(57) ABSTRACT

A system and method for generating real-time promotions to a visitor of an electronic commerce (e-commerce) World Wide website to increase the likelihood of purchase on the website by the visitor. The system and method receive and store clickstream data provided by the visitor, and calculate the probability that the visitor will leave the website or will make a purchase on the website based upon this clickstream data. The system and method then utilize the calculated probabilities, as well as the frequency of visits to the website by the visitor, and the time of the visit to the website, to decide whether or not real-time promotions should be generated on the website. If it is decided that promotions should be generated, then the system and method automatically calculate what promotions to send, when to send them, and how to send them. The system and method enable e-commerce owners and managers to better direct their promotions, enable promotions to be tailored to the visitors' display preferences, and generate the right promotion at the right time and the right place. Furthermore, the system and method become increasingly effective and refined with more visitors to the e-commerce website, providing the e-commerce website owner or manager with a better understanding of his or her customers, increased revenue, and greater marketing efficiency. The visitors to the e-commerce website, in turn, receive better service, information and value.

### BACKGROUND OF THE INVENTION

A. Field of the Invention

The present invention relates generally to a system and method for behavior profiling and modeling on any electronic commerce (e-commerce) website on the World Wide Web (WWW) or Internet, and, more particularly, to a system and method for generating real-time promotions on the e-commerce website to increase the likelihood of purchase.

B. Description of the Related Art

In the past couple of years there has been an explosive growth in the use of a globally-linked network of computers known as the Internet, and in particular of the WWW, which is one of the facilities provided on top of the Internet. The WWW comprises many pages or files of information, distributed across many different server computer systems. Information stored on such pages can be, for example, details of a company's organization, contact data, product data and company news. This information can be presented to the user's computer system (“client computer system”) using a combination of text, graphics, audio data and video data. Each page is identified by a Universal Resource Locator (URL). The URL denotes both the server machine, and the particular file or page on that machine. There may be many pages or URLs resident on a single server.

In order to use the WWW, a client computer system runs a piece of software known as a graphical Web browser, such as the Navigator® program available from Netscape® Communications Corporation. The client computer system interacts with the browser to select a particular URL, which in turn causes the browser to send a request for that URL or page to the server identified in the URL. Typically the server responds to the request by retrieving the requested page, and transmitting the data for that page back to the requesting client computer system (the client/server interaction is performed in accordance with the hypertext transport protocol (“HTTP”)). This page is then displayed to the user on the client screen. The client may also cause the server to launch an application, for example to search for WWW pages relating to particular topics.

Most WWW pages are formatted in accordance with a computer program written in a language known as HTML (hypertext markup language). This program contains the data to be displayed via the client's graphical browser as well as formatting commands which tell the browser how to display the data. Thus a typical Web page includes text together with embedded formatting commands, referred to as tags, which can be used to control the font size, the font style (for example, whether italic or bold), how to layout the text, and so on. A Web browser “parses” the HTML script in order to display the text in accordance with the specified format. HTML tags are also used to indicate how graphics, audio and video are manifested to the user via the client's browser.

In rapidly growing numbers, businesses and consumers are moving their routine commercial activities into the electronic marketplace of the WWW (this phenomenon is known as electronic commerce, or simply e-commerce). The growth of electronic networks has given businesses of all sizes unprecedented access to new markets. Many businesses have begun to sell their goods and services over the WWW by placing their catalogues on their Web pages, such catalogues listing content-related information (e.g. product description, price, availability) about the various goods and services offered for sale. It is fairly common for a consumer to browse a business' catalog, select a product, place an order for the product, and pay for the product all electronically over the Internet.

### SUMMARY OF THE INVENTION

An object of the invention is to increase the likelihood of a purchase on an e-commerce website through consumer behavior analysis and modeling.

Another object of the invention is to provide an e-commerce website owner or manager with a better understanding of his or her customers, increased revenue, and greater marketing efficiency.

Still another object of the invention is to provide visitors to an e-commerce website with better service, information and value.

In accordance with the purpose of the invention, as embodied and broadly described herein, the invention comprises a system for generating real-time promotions on a website to increase the likelihood of purchase on the website, the system including: a memory configured to store instructions; and a processor configured to execute instructions for: receiving and storing clickstream data from a visitor to the website, calculating the probability that the visitor will leave the website and the probability that the visitor will make a purchase on the website based upon the clickstream data, utilizing the calculated probabilities, the frequency of visits to the website by the visitor, and the time of the visit to the website, to decide whether real-time promotions should be generated on the website, and automatically calculating what promotions to send, when to send them, and how to send them, if real-time promotions are to be generated.

Further in accordance with the purpose, the present invention comprises a computer-implemented method for generating real-time promotions on a website to increase the likelihood of purchase on the website, the method including the steps of: receiving and storing clickstream data from a visitor to the website; calculating the probability that the visitor will leave the website and the probability that the visitor will make a purchase on the website based upon the clickstream data; utilizing the calculated probabilities, the frequency of visits to the website by the visitor, and the time of the visit to the website, to decide whether real-time promotions should be generated on the website; and automatically calculating what promotions to send, when to send them, and how to send them, if real-time promotions are generated in the utilizing step.

Still further in accordance with the purpose, the present invention comprises a computer readable medium that stores instructions executable by at least one processor to perform a method for generating real-time promotions on a website to increase the likelihood of purchase on the website, including: instructions for receiving and storing clickstream data from a visitor to the website; instructions for calculating the probability that the visitor will leave the website and the probability that the visitor will make a purchase on the website based upon the clickstream data; instructions for utilizing the calculated probabilities, the frequency of visits to the website by the visitor, and the time of the visit to the website, to decide whether real-time promotions should be generated on the website; and instructions for automatically calculating what promotions to send, when to send them, and how to send them, if real-time promotions are generated in the utilizing step.

### BRIEF DESCRIPTION OF THE DRAWINGS

The accompanying drawings, which are incorporated in and constitute a part of this specification, illustrate one embodiment of the invention and together with the description, serve to explain the principles of the invention. In the drawings:

FIG. 1 is a schematic diagram showing a system of an embodiment of the present invention;

FIG. 2 is a schematic diagram showing a client, server, or client/server of the system of FIG. 1;

FIG. 3 is a schematic diagram showing the primary components of the system shown in FIG. 1;

FIG. 4 is a schematic diagram showing the primary components of the system shown in FIG. 1;

FIG. 5 is a sample screen showing a graphical user interface that aggregates data for a business manager in the system shown in FIG. 1;

FIGS. 6A and 6B are sample screens showing the graphical user interface that displays the rules-based engine and models that can be deployed by the system of FIG. 1;

FIG. 7 is an example of how the system and method of the present invention may be applied given different visitor datapoints;

FIG. 8 is a flowchart of the major steps of a method for collecting visitor data points and information in accordance with the present invention;

FIG. 9 is a flowchart of the major steps of a method for providing real-time response to the visitor and recording the results in accordance with the present invention; and

FIG. 10 is a sample screen showing the graphical user interface that displays the promotions create/edit function that may be deployed by the system of FIG. 1.

### DESCRIPTION OF THE PREFERRED EMBODIMENT

Reference will now be made in detail to the present preferred embodiment of the invention, an example of which is illustrated in the accompanying drawings. Wherever possible, the same reference numbers will be used throughout the drawing to refer to the same or like parts.

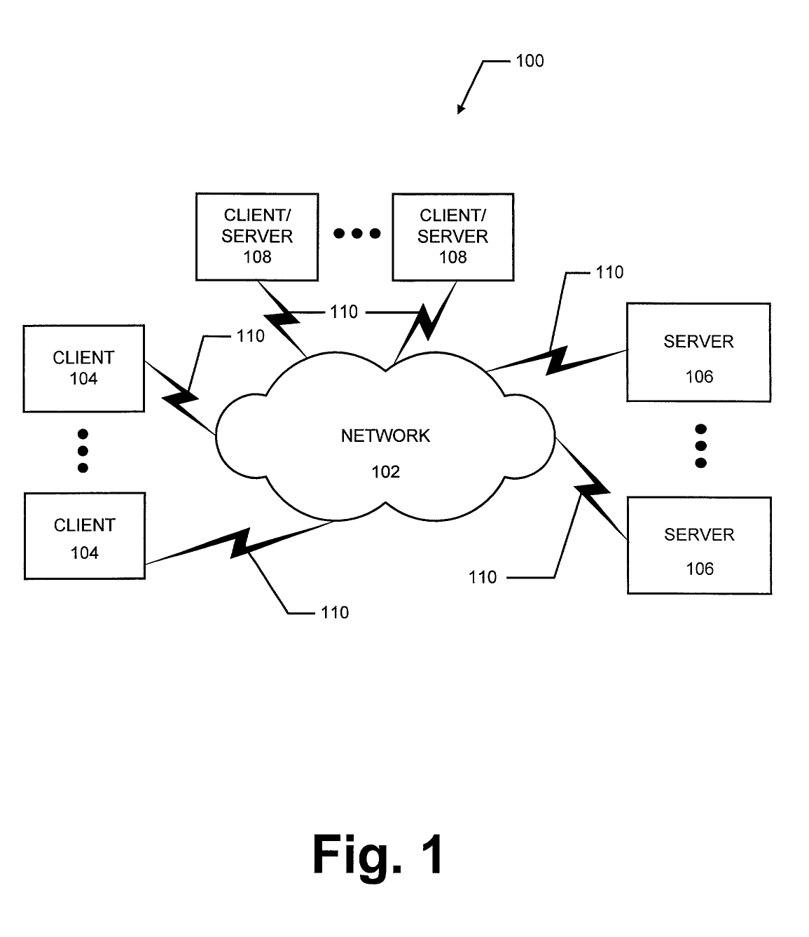

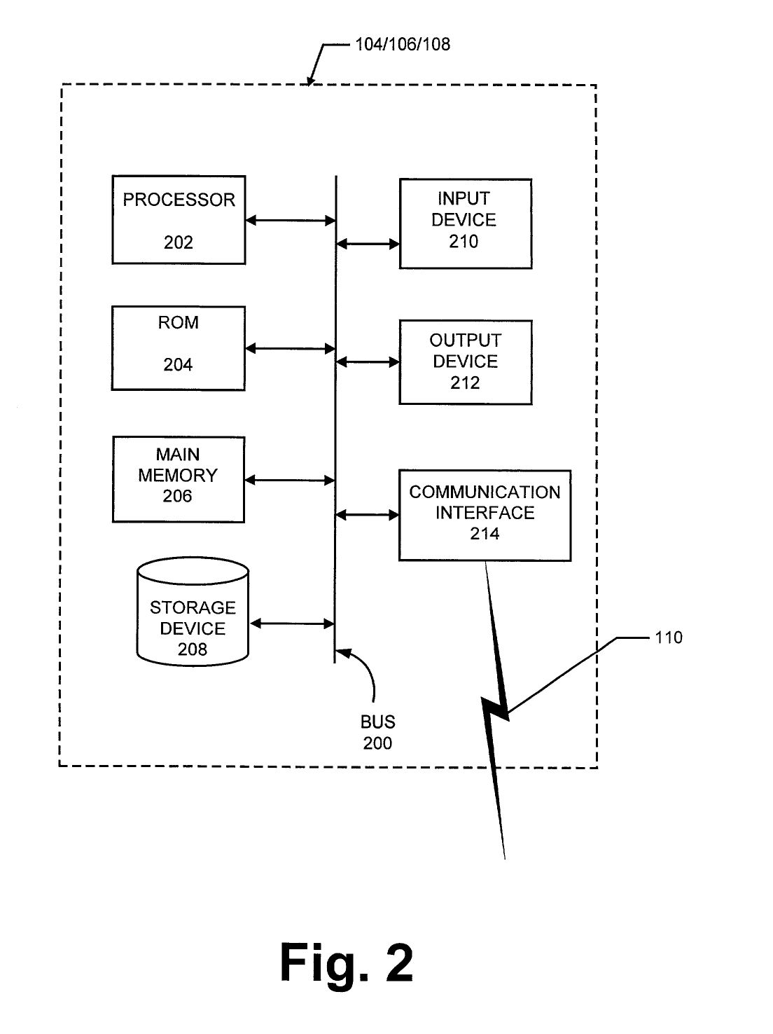

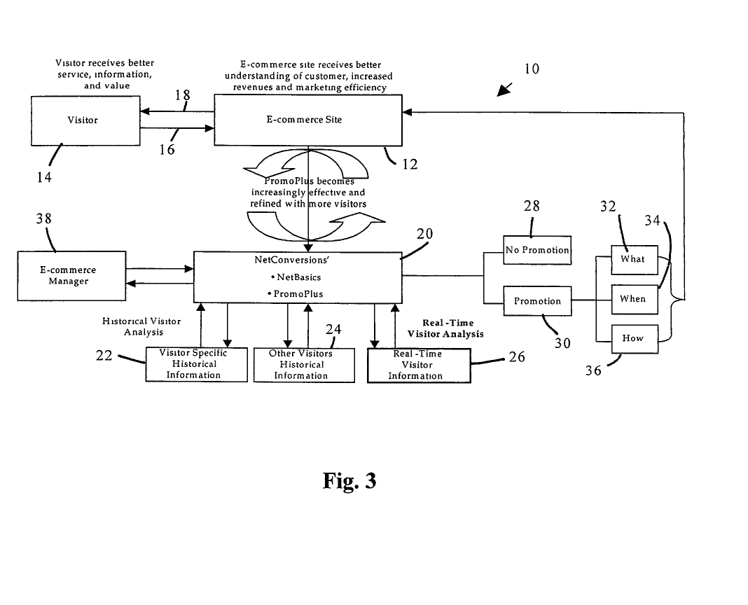

In accordance with the invention and as shown in FIG. 1, the system 100 of the present invention includes a network 102 that interconnects client entities 104, server entities 106 and client/server entities 108 via communication links 110.

Network 102 may comprise an Internet, intranet, extranet, local area network (LAN), wide area network (WAN), metropolitan area network (MAN), telephone network such as the public switched telephone network (PSTN), or a similar network.

The Internet is a collection of interconnected (public and/or private) networks that are linked together by a set of standard protocols (such as TCP/IP and HTTP) to form a global, distributed network. While this term is intended to refer to what is now commonly known as the Internet, it is also intended to encompass variations which may be made in the future, including changes and additions to existing protocols.

An intranet is a private network that is contained within an enterprise. It may consist of many interlinked local area networks and also use leased lines in the wide area network. Typically, an intranet includes connections through one or more gateway computers to the outside Internet. The main purpose of an intranet is to share company information and computing resources among employees. An intranet can also be used to facilitate working in groups and for teleconferences. An intranet uses TCP/IP, HTTP, and other Internet protocols and in general looks like a private version of the Internet. With tunneling, companies can send private messages through the public network, using the public network with special encryption/decryption and other security safeguards to connect one part of their intranet to another. Typically, larger enterprises allow users within their intranet to access the public Internet through firewall servers that have the ability to screen messages in both directions so that company security is maintained. When part of an intranet is made accessible to customers, partners, suppliers, or others outside the company, that part becomes part of an extranet.

An extranet is a private network that uses the Internet protocols and the public telecommunication system to securely share part of a business's information or operations with suppliers, vendors, partners, customers, or other businesses. An extranet can be viewed as part of a company's intranet that is extended to users outside the company.

A LAN refers to a network where computing resources such as PCs, printers, minicomputers, and mainframes are linked by a common transmission medium such as coaxial cable. A LAN usually refers to a network in a single building or campus. A WAN is a public or private computer network serving a wide geographic area. A MAN is a data communication network covering the geographic area of a city, a MAN is generally larger than a LAN but smaller than a WAN.

PSTN refers to the world's collection of interconnected voice-oriented public telephone networks, both commercial and government-owned. It is the aggregation of circuit-switching telephone networks that has evolved from the days of Alexander Graham Bell. Today, PSTN is almost entirely digital in technology except for the final link from the central (local) telephone office to the user. In relation to the Internet, the PSTN actually furnishes much of the Internet's long-distance infrastructure.

An entity may include software, such as programs, threads, processes, information, databases, or objects; hardware, such as a computer, a laptop, a personal digital assistant (PDA), a wired or wireless telephone, or a similar wireless device; or a combination of both software and hardware. A client entity 104 is an entity that sends a request to a server entity and waits for a response. A server entity 106 is an entity that responds to the request from the client entity. A client/server entity 108 is an entity where the client and server entities reside in the same piece of hardware or software.

Connections 110 may be wired, wireless, optical or a similar connection mechanisms. “Wireless” refers to a communications, monitoring, or control system in which electromagnetic or acoustic waves carry a signal through atmospheric space rather than along a wire. In most wireless systems, radio-frequency (RF) or infrared (IR) waves are used. Some monitoring devices, such as intrusion alarms, employ acoustic waves at frequencies above the range of human hearing.

An entity, whether it be a client entity 104, a server entity 106, or a client/server entity 108, includes a bus 200 interconnecting a processor 202, a read-only memory (ROM) 204, a main memory 206, a storage device 208, an input device 210, an output device 212, and a communication interface 214. Bus 200 is a network topology or circuit arrangement in which all devices are attached to a line directly and all signals pass through each of the devices. Each device has a unique identity and can recognize those signals intended for it. Processor 202 includes the logic circuitry that responds to and processes the basic instructions that drive entity 104, 106, 108. ROM 204 includes a static memory that stores instructions and date used by processor 202.

Computer storage is the holding of data in an electromagnetic form for access by a computer processor. Main memory 206, which may be a RAM or another type of dynamic memory, makes up the primary storage of entity 104, 106, 108. Secondary storage of entity 104, 106, 108 may comprise storage device 208, such as hard disks, tapes, diskettes, Zip drives, RAID systems, holographic storage, optical storage, CD-ROMs, magnetic tapes, and other external devices and their corresponding drives.

Input device 210 may include a keyboard, mouse, pointing device, sound device (e.g. a microphone, etc.), biometric device, or any other device providing input to entity 104, 106, 108. Output device 212 may comprise a display, a printer, a sound device (e.g. a speaker, etc.), or other device providing output to entity 104, 106, 108. Communication interface 214 may include network connections, modems, or other devices used for communications with other computer systems or devices.

As will be described below, an entity 104, 106, 108 consistent with the present invention may generate real-time promotions on a website to increase the likelihood of purchase on the website. Entity 104, 106, 108 performs this task in response to processor 202 executing sequences of instructions contained in a computer-readable medium, such as main memory 206. A computer-readable medium may include one or more memory devices and/or carrier waves.

Execution of the sequences of instructions contained in main memory 206 causes processor 202 to perform processes that will be described later. Alternatively, hardwired circuitry may be used in place of or in combination with software instructions to implement processes consistent with the present invention. Thus, the present invention is not limited to any specific combination of hardware circuitry and software.

The present invention is drawn broadly to a system and method for developing a beta-binomial probability analysis of an e-commerce website visitor's clickstream data to develop probabilities of when a user may leave the site or make a purchase on the site. More specifically, the present invention is drawn to a system and method for developing a rules-based promotional engine that allows an e-commerce website owner or manager to build realtime promotions that are capable of being delivered through a series of rules.

In accordance with the invention and as shown in FIG. 1, the present invention includes a system 10 for developing a rule-based promotional engine for an e-commerce website 12. When a visitor 14 enters the e-commerce website 12 through a common Internet protocol, e-commerce website 12 generates an initial web page (commonly known as a “Home Page”) for display to visitor 14. During the visitor's first visit, the Home Page provides menu selections of content-related information (e.g. product description, price, availability) about the various goods and services offered for sale by the e-commerce website owner. Visitor 14 enters “clickstream data” 16 (input data provided by using a click of a mouse or other input means), and e-commerce website 12 displays corresponding information 18 to visitor 14 based upon the clickstream data 16 entered by visitor 14. For example, visitor 14 may point and click on a specific product sold on e-commerce website 12, and website 12, in turn, may display a picture of the product along with a product description. This type of information is provided to a software program 20 stored on a website owned by NetConversions, the assignee of the present invention, as long as a manager or owner 38 of e-commerce website 12 deploys software program 20.

Software program 20 records the visitor's 14 selections and his or her viewing activity with respect to the e-commerce website 12. In particular, software program 20 records the date and time of the visitor viewing and the items that the visitor 14 has selected for viewing. After multiple sessions, a pattern of the visitor's viewing actions or viewing habits is obtained from the recorded activity. Software program 20 stores this specific information provided by visitor 14 in a visitor-specific historical information data file 22. Software program 20 also stores this same type of information for other visitors in historical information data files unique to each of the other visitors. For ease of reference, the other visitors historical information data files are shown generally as reference numeral 24. While visitor 14 is currently accessing e-commerce website 12, software program 20 stores the current information provided by visitor 14 in a real-time visitor information data file 26. Once visitor 14 leaves the WWW, software program 20 writes the information provided in real-time visitor information data file 26 to visitor-specific historical information data file 22.

When visitor 14 enters e-commerce website 12, software program 20 utilizes the information stored in visitor-specific, historical and real-time information data files 22, 26, and other visitors historical information data files 24, and, accordingly calculates probabilities about when visitor 14 may leave website 12 or make a purchase on website 12 using a beta-binomial probability model. Software program 20 utilizes the calculated probability of purchase, the calculated probability of leaving website 12, as well information regarding the frequency of visits to website 12 by visitor 14 (or whether it is visitor's 14 first visit to website 12) and the time of the visit, to automatically decide whether or not to send a promotion 28, 30 (such as, for example, an advertisement, an offer, or a coupon). If program 20 decides to send a promotion 30, it sends the promotion 32 dictated by e-commerce manager 38 based upon a rule set by manager 38, wherein manager 38 may tie a promotion to a probability. Program 20 further decides when to send the promotion 34, and how to send the promotion 36.

Software program 20 may also interact with manager or owner 38 of e-commerce website 12 to dictate the delivery mechanism for the promotion. For example, manager or owner 38 might want the promotion sent to visitor 14 via one of the following means: electronic mail (e-mail), interstitial (a pop-up window on e-commerce website 12), embedded promotion (such as through a banner advertisement within website 12), virtual call center (website 12 asks if visitor 14 needs help and assists visitor 14 with his or her problem), live text chat over website 12, facsimile, or live telephone call. This permits manager or owner 38 to have some control over his e-commerce website's promotional activities.

Based on the created visitor data files 22, 24, 26, the system and method of the present invention enable e-commerce owners and managers to better direct their promotions, enable promotions to be tailored to the visitors' display preferences, and generate the right promotion at the right time and the right place. That is, both the subject matter and the presentation of promotions may be customized to the visitor's preferences due to the information tracked and recorded by software program 20.

Furthermore, the system and method of the present invention become increasingly effective and refined with more visitors to the e-commerce website. The present invention also provides the e-commerce website owner or manager with a better understanding of his or her customers, increased revenue, and greater marketing efficiency. The visitors to the e-commerce website, in turn, receive better service, information and value.

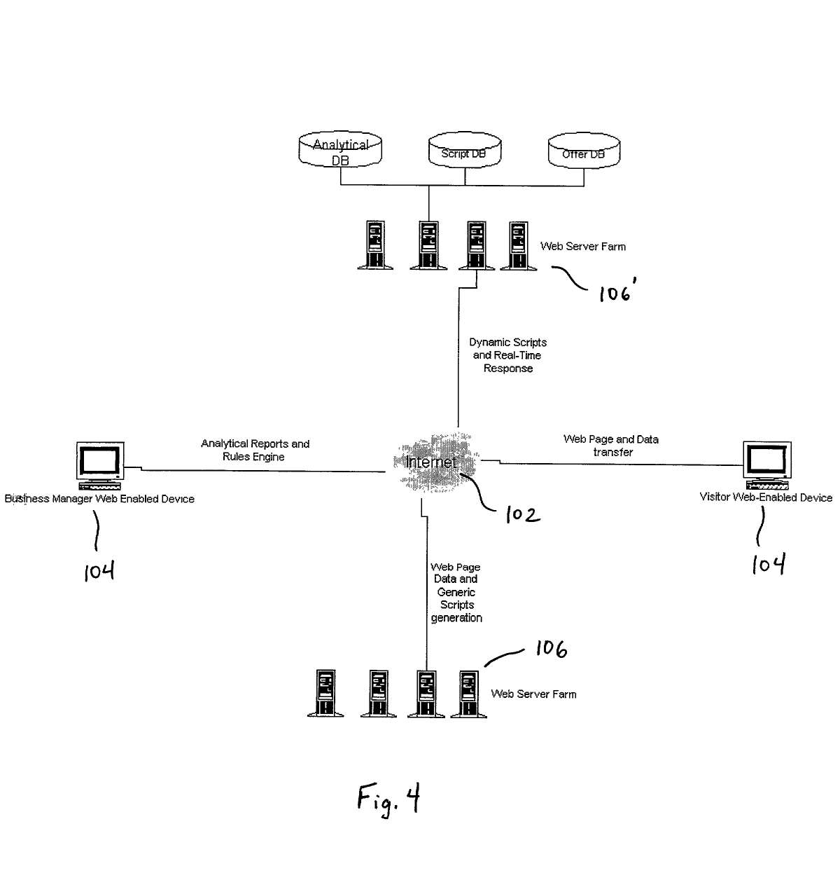

FIG. 4 is a block diagram of a data flow in accordance with the principles of the invention. When a visitor 14 visits any website 12 (e.g., www.yahoo.com), via a visitor client entity 104, a web page request is sent to a web server entity 106 that delivers web page data, via network 102. Web server 106 also sends additional generic script information (which is a client side script that instructs the browser to collect information and gather additional scripting information from the script database 300) to the visitor client entity 104. The generic script then invokes a response from another web server entity 106′ that delivers dynamic scripts from a script database 300 to visitor client entity 104. Web server entity 106′ contains software program 20 discussed above. The dynamic scripts collect unique ID information along with page data information of the visitor 14 that is sent back to web server 106′ and processed to see if a real-time response is necessary. If a real-time response is necessary, the message is sent directly back to the visitor 14. All the data is captured in an analytical database 302 of web server 106′ and processed into a User Interface that a business manager 38 can access via a business manager client entity 104. Business manager client entity 104 is also capable of setting rules in an offer database 304 of web server entity 106′ that generates the real-time responses a visitor may see on visitor client entity 104. The owner of web server 106′ sets the script database, and the owner of web server 106 designs the web pages.

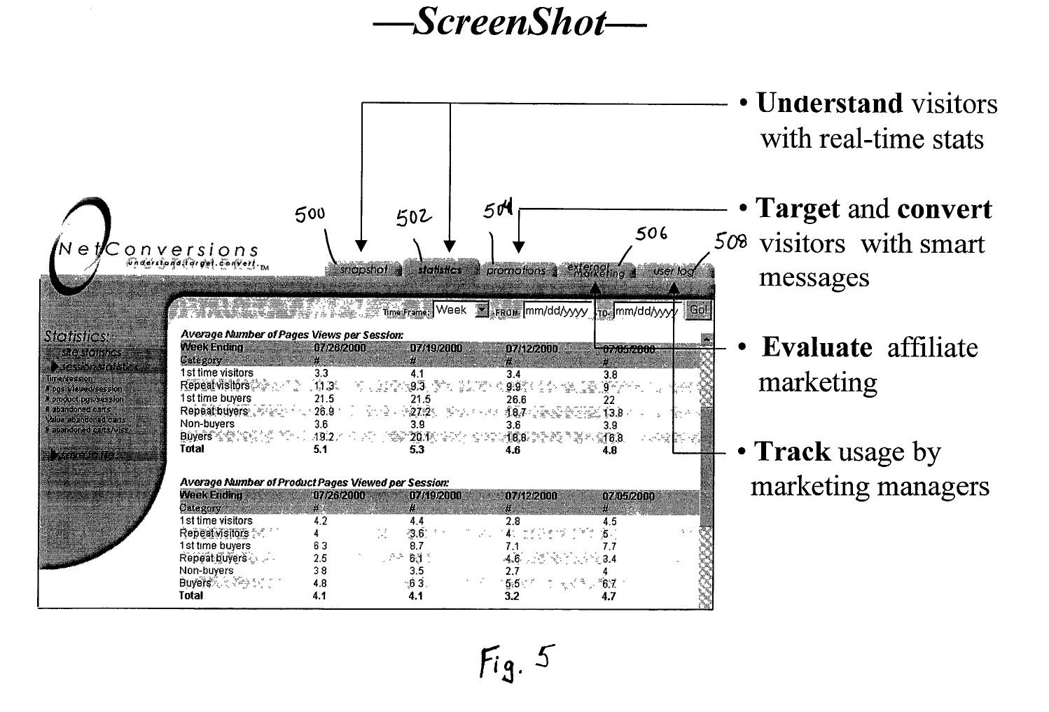

FIG. 5 is a sample screen showing the graphical user interface provided by web server 106′, aggregating the data for the business manager client entity 104. The snapshot tab 500 shows aggregate information in real-time regarding site statistics in summary form, such as, for example, number of visitors, conversion rates, and aggregated stats. The statistics tab 502 shows aggregate information in more detail. The promotions tab 504 allows the business manager to set rules for real-time response messages, and displays results from the response. Real-time behavior models may also be set in this interface, such as, for example, setting a promotion to be executed when the probability of exiting the site exceeds 90%. The external marketing tab 506 displays data regarding external marketing campaigns and return on investment data regarding those campaigns, such as, for example, banner ads on external sites or newspaper ads that direct traffic to a specific URL. The User log 508 tracks all the transactions created by the business manager client entity 104 and also sets security settings for the business manager client entity 104.

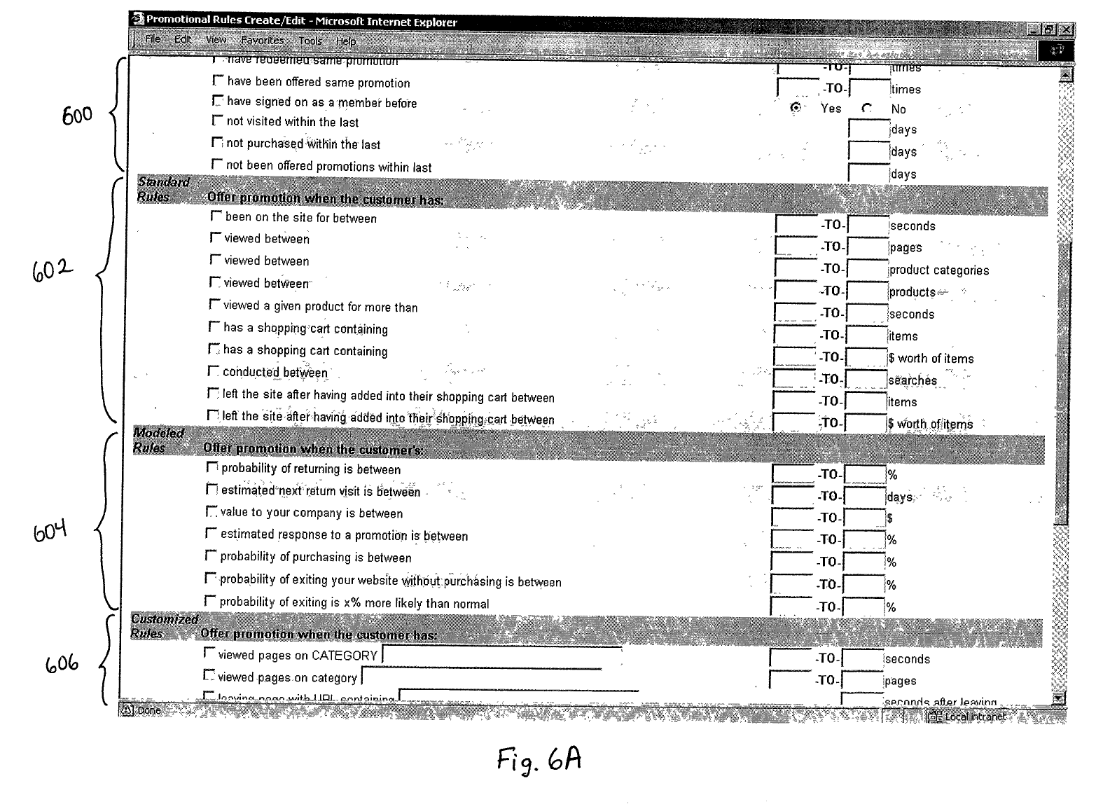

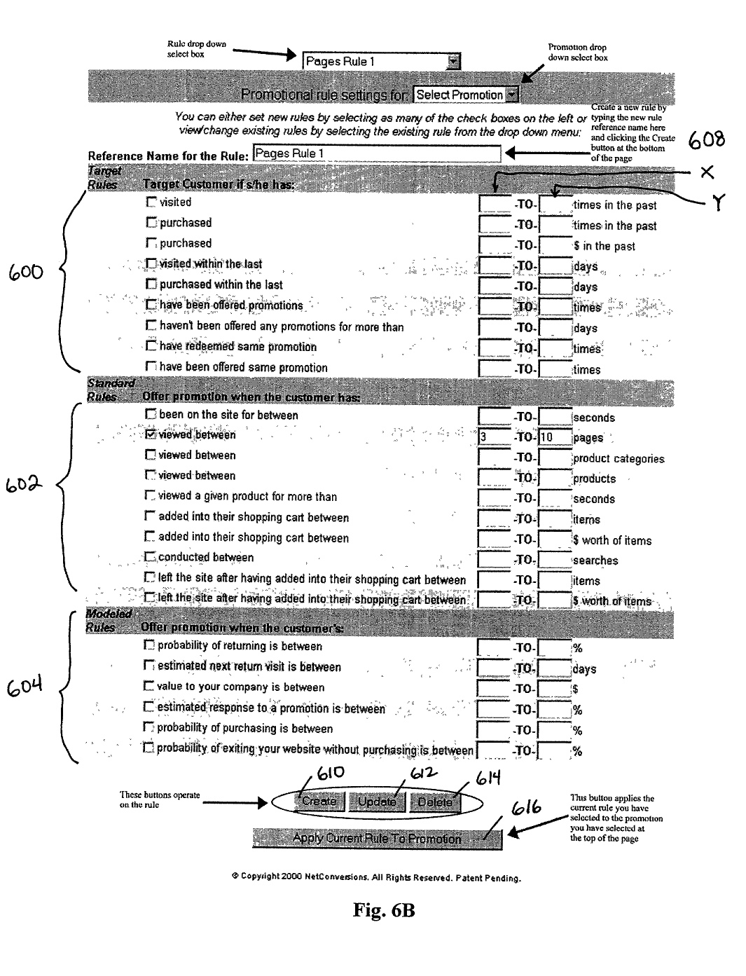

FIG. 6A is a sample screen showing the graphical user interface that displays the rules-based engine and models that can be deployed. The rules-based engine provides four categories of rules. Target rules 600 are based on prior historical behavior exhibited by the visitor of web server entity 106. For example, a rule may be set to trigger if someone has visited 5 times in the past or has purchased 3 times in the past. Standard rules 602 are based on current visitor behavior at web server entity 106. For example, a rule may be set to trigger if someone has visited a certain number of pages or been on the site several seconds. The modeled rules 604 are based on real-time, Bayesian updating models that allow a manager to trigger a rule based on probabilities (described below). For example, a rule may be set to trigger if someone has a 90% probability of leaving the site. The customized rules 606 are based on cross-sell/up-sell opportunities (such as when a visitor buys a suit, a tie will be cross-sold) and exit-based promotions (such as a promotion that is triggered when someone leaves the site). For example, a rule may be set to trigger if someone has a certain item in their cart and the business manager wants to cross-sell another item with it. All the rules that are capable of being deployed can be combined in “AND” rules. For example, a manager may be able to target a specific visitor that has visited ten times in the past and bought three times in the past, and been on the site twenty seconds, and has shoes in the shopping basket. A detailed description of these rules is given below with reference to FIG. 6B.

FIG. 6B is a sample screen showing the graphical user interface that displays the rules-based engine and models that can be deployed. After the creation of a new promotion, rules must applied in order to launch. The business manager performs this action in the create/edit rules page shown in FIGS. 6A and 6B. The create/edit rules page is used for more than just the purpose of setting the rule for the new promotion. From the create/edit rules page, the business manager can create, update, and delete rules as separate entities.

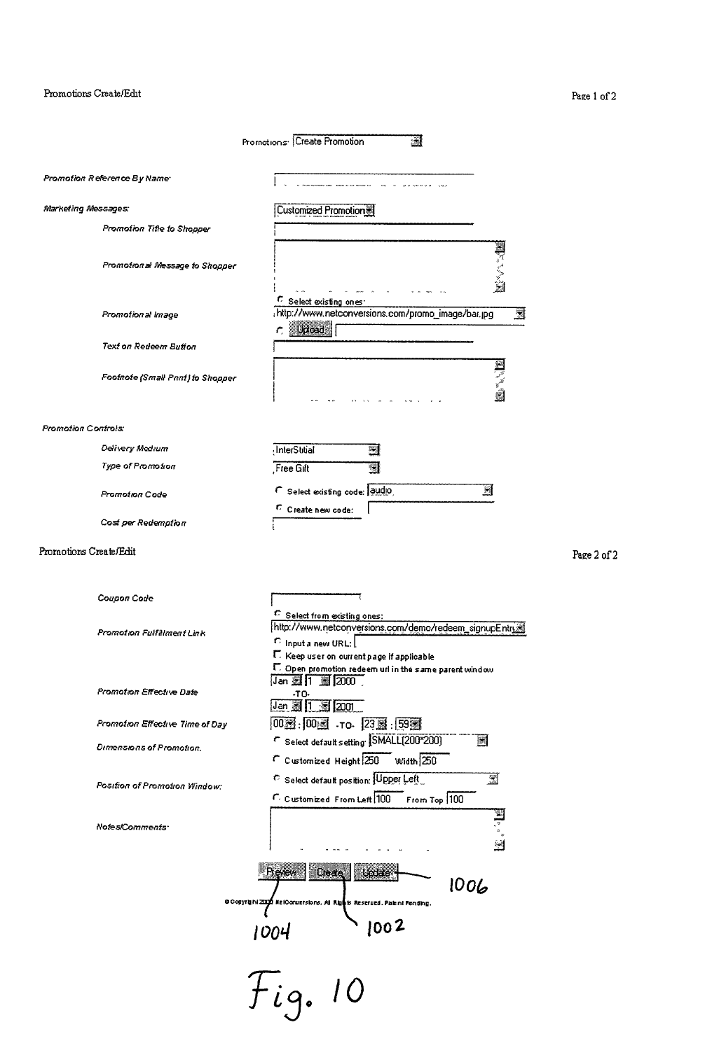

Two methods may be used to create a promotion. One method is to pre-create a promotion without using the interface described below in FIG. 10, and then loading the HTML-based promotion into the system of the present invention. This allows flexibility for the designer to create a promotion without the promotion creation tool. The promotion creation tool as seen in FIG. 10 allows the user to design a promotion without knowing HTML. Each of the fields is customizable to the user's design - such as, name of the promotion, text of the promotion, size of the promotion, and delivery time of the promotion. After designing the promotion, the user may click on the create button 1002 to create the promotion, the preview button 1004 to preview the promotion, or the update button 1006 to update an existing promotion. After creation of the rules to be set, the user must apply the rules to the promotion by clicking on the “Apply Current Rule To Promotion” button 616 (as shown in FIG. 6B).

As shown in FIG. 10, a user (business manager) may name the promotion in the Promotion Reference By Name field; provide a title to the promotion in the Promotion Title to Shopper field; provide a message to the shopper in the Promotional Message to Shopper field; attach a Promotional Image to the promotion; supply the Text on Redeem Button; include a footnote in the Footnote (Small Print) to Shopper field; set the delivery medium of the promotion in the Delivery Medium field; set the type of promotion in the Type of Promotion field; set a Promotion code (e.g., audio, visual, etc.); set the cost per redemption in the Cost per Redemption field; supply a Coupon Code; provide a Promotion Fulfillment Link; set the Promotion Effective Date and Time of Day; set the Dimensions of the Promotion; set the Position of Promotion Window; and add notes or comments.

The promotion object encapsulates the content and settings of the promotion itself. This includes the image, text, redeem URL, dimensions, as well as other parameters that may or may not directly affect the end user who receives the promotion. The promotion itself does not encompass the functionality that actually triggers the promotion to be delivered to the end user. This functionality is separated away from the promotion object and encapsulated into its own object called the rule, that is triggered by the end user's (visitor's) behavior. Promotions are linked to rules after the rule is created (or updated). Each promotion has only one rule applied to it, however, each rule may have multiple sub-rules contained within.

The rule object encapsulates the functionality of triggering a promotion when all the sub-rules are met by the end user's behavior. Rules are separate objects and can be created, updated, and deleted separate from promotions. Thus, the marketing (business) manager can have rules existing in his/her system that aren't linked to any promotions at all. The motivation for this separation is to allow for the creation of a library of rules to use in certain circumstances. When a new promotion is created, the marketing manager just applies the existing rule to the new promotion without having to recreate the rule.

Each promotion can have at most one rule applied to it. Each rule can have multiple sub-rules contained within it. A rule is met if all sub-rules are met. The sub-rules are listed on the create/edit rules page (FIG. 6B) and segmented into four types Target Rules 600, Standard Rules 602, Modeled Rules 604, and Customized Rules 606. These rules represent different levels of targeting: Target Rules 600, apply at individual (visitor) level; Standard Rules 602, apply to a current web session, not visitor; Model Rules 604, set for probability.

The create/edit rules page (FIG. 6B) allows the marketing manager to create, update, and delete rules for promotions. To create a new rule, the marketing manager must enter a new rule reference name in the Reference Name for the Rule field 608 then add the sub-rules for this rule (clicking the check boxes to the left of the individual sub-rules desired); set the parameters for the sub-rules (input text boxes to the right of the sub-rules desired); and click on the Create button 610 at the bottom of the page. In order to update an existing rule, select the rule to be updated and change the necessary parameters. Then click Update button 612. To erase rules from the system, one must select those rules and click Delete button 614 at the bottom of the page. All three of these actions can be applied to rules (create, update, delete). To apply a rule to a particular promotion, one must click the “Apply Current Rule To Promotion” button 616.

If the marketing manager wishes to update the sub-rule settings for a particular promotion, the marketing manager has two options: either create a new rule for this promotion and then apply that new rule to the existing promotion, or modify the existing rule that is already applied to the promotion. If modify is chosen, the rule will be updated independent of the promotion. This has the effect of changing the sub-rule settings for all promotions that have this same rule applied to them.

In the subsections that follow, X and Y refer respectively to the left and right input fields for each sub-rule. The parameter Y should always be greater than or equal to the parameter X. If the parameter X is left blank, it is interpreted as zero. If the parameter Y is left blank, it is interpreted as a maximum value with no limit (infinite). Further, the range X to Y is inclusive. That is, if a sub-rule is triggered by an event within the range X to Y, this is interpreted as, “The event took place at least X times and no more than Y times.”

Target Rules 600 are a subset of the sub-rules that apply to the end user at the individual level. This contrasts the Standard Rules 602 subset in that the Standard Rules don't apply to the visitor but rather only to the current web session. For example, the Target Rule “Visited X to Y Times in the Past” is dependent on the individual visitor's previous visit history whereas the Standard Rule “Been on the Site for Between X and Y Seconds” applies to all visitors who meet this sub-rule in their current web session. The “Visited X to Y Times in the Past” sub-rule allows the marketing manager to target the visitor based on the visitors previous visit history. For example, this sub-rule can be used to target first time visitors only by specifying the range (X to Y) to be 0 to 0. That is, this sub-rule is satisfied only when the visitor has visited at least 0 times in the past and no more than 0 times in the past (hence targeting first time visitors). This sub-rule can also be used to target frequent visitors, say for example, the range (X to Y) 10 to 15. This sub-rule would only be satisfied if the visitor has visited at least 10 times in the past and no more than 15 times in the past. In order to create a limitless rule, leave Y blank.

The “Purchased X to Y Times in the Past” sub-rule enables visitors to be targeted based on their purchase history. For this specific sub-rule, the visitor is targeted by how many times s/he has purchased in the past. For example, if the parameters X and Y are set to 3 and 6 respectively, visitors who have purchased at least 3 times and no more than 6 times trigger this sub-rule.

The “Purchased X to Y $ in the Past” sub-rule targets visitors based on their previous purchase history measured by the amount the visitor has spent in the past. For example, if the parameters X and Y are set to 50 and 100, this sub-rule will be triggered for visitors who have spent at least $50 and no more than $100 in the past. This sub-rule is useful for targeting valued customers. Another application of this sub-rule is to offer promotions to visitors who have spent less than a certain amount, say $20. In this case, the X and Y parameters would be set to 0 and 20 respectively.

The visitor can be targeted based on his/her previous visit history in the recent past. The “Visited Within the Last X to Y Days” sub-rule provides the sub-rule to target this behavior. For example, to target visitors who have visited between 3 and 5 days in the past, the parameters X and Y would be set to 3 and 5 respectively. To target visitors who have visited within the last 3 days, the parameters X and Y would be set to 0 and 3.

The “Purchased Within the Last X to Y Days” sub-rule allows a visitor to be targeted based on his/her purchase history within a specified time period. For example, if the marketing manager desires to target visitors who have purchased within the last 5 days but have not purchased within the last 2 days, the parameters X and Y would be set to 2 and 5 respectively.

Visitors can also be targeted based on their previous promotion history. The “Have Been Offered Promotions X to Y Times” sub-rule allows promotions to be delivered to visitors who have been offered promotions at least X times and no more than Y times in the past. For example, if the marketing manager wishes to give a promotion to visitors who have never received a promotion before, the parameters X and Y would take on the values 0 and 0. The marketing manager should be aware that using an X value of 1 or greater would result in visitors who have never received a promotion in the past to not receive any promotion containing this sub-rule (with X1 or greater).

The “Have Redeemed Same Promotion X to Y Times” sub-rule allows the marketing manager to target visitors who have redeemed the same promotion in the past a specified amount of times. Suppose the marketing manager creates a promotion to encourage visitors to sign up for a contest or register themselves. In order to deliver this only to visitors who have never before redeemed the promotion, the parameters X and Y would both be set to 0. That is, this sub-rule is triggered for visitors who have redeemed the same promotion at least 0 times and no more than 0 times in the past. Once the visitor redeems the promotion, their “redeem promotion count” is at least 1, and the visitor will no longer receive this particular promotion again. The “Have Been Offered Same Promotion X to Y Times” sub-rule is triggered when visitors have been offered the same promotion at least X and no more than Y times in the past. A typical application of this sub-rule is to only give a promotion to a visitor once. In this case, the parameters X and Y would both be set to zero. The marketing manager should be aware that if this sub-rule were the only one contained within the rule and X is 1 or greater, the visitor would never receive this promotion. Thus the X parameter should always be zero (or blank) when using this sub-rule.

The Standard Rules 602 are a subset of the sub-rules that apply to the current web session independent of the visitor's previous visit, purchase, or promotion history. These are triggered for every visitor who meets the specified sub-rule criteria for the web session as described in the subsections that below.

The “Been on the Site Between X to Y Seconds” sub-rule allows the marketing manager to target visitors based on the their current time spent on the website measured in seconds. For example, the marketing manager can offer a promotion to visitors who have been on the site for 5 minutes (300 seconds). To do this, the range (X to Y) would be set at between 300 to 301. Then in this example, the sub-rule is satisfied when the visitor has been on the site for 300 seconds.

The “Viewed Between X to Y Pages” sub-rule allows the marketing manager to target visitors based on how many pages s/he has viewed. This includes the entry page. For example, the marketing manager can offer a promotion to visitors who have viewed 12 pages. To do this, the range would be set at between 12 and 13. This sub-rule would be satisfied only when the visitor has viewed at least 12 pages and no more than 13 pages. In the case that the marketing manager sets the range to 0 and 1 then the visitor will receive the promotion on the entry page.

The “Viewed Between X to Y Product Categories” sub-rule allows the marketing manager to single out visitors based on how many product categories, in terms of pages, viewed. This will depend on how the website is categorized. For example, a promotion can be offered to visitors if they have viewed 1 product category page by setting the range at between 1 and 2. If this sub-rule is used alone and set to the range between 0 and 1, then the promotion will be triggered on the homepage because the homepage is not categorized as a product category page. Similarly, a visitor can click through the homepage and many information pages without satisfying a range that is set between 1 and 2. This is due to the fact that the visitor has viewed many pages but not on product category pages. Therefore, the marketing manager should have a firm grasp as to how pages are categorized.

The “Viewed Between X to Y Products” sub-rule allows the marketing manager to target visitors based on how many products that they have viewed. For example, a book page on Amazon.com may have 10 books. This would be considered a product category page and not a product page. However, if that visitor clicked on one of those 10 books then that would equate to viewing 1 product. In this example, a promotion would be triggered if the range were set on 1 to 2. If that range was set at between 0 to 1, then the sub-rule would be triggered when the visitor hits the homepage because they would have viewed 0 product pages.

The “Viewed a Given Product for More Than X to Y Seconds” sub-rule is good for targeting a customer that may need some coercion to complete a sale. It works by noticing the visitor has looked at a product for a specified amount of time and then offers a promotion. For example, if the range was set at 30 to 31 seconds, then this sub-rule would be triggered if the cumulative number of seconds of product page views is at least 30 seconds and no more than 31 seconds even if the visitor has been on the site more than 30 seconds. In this example, a visitor could spend 10 seconds on the homepage, 10 seconds on the product category page, 10 seconds on a product page, 10 seconds on an information page, 10 seconds on a product category page, and then 20 seconds on a product page to finally satisfy the range of this sub-rule at 30 seconds.

The “Has a Shopping Cart Containing X to Y Items” sub-rule enables the marketing manager to target visitors based on how many items are in the visitor's shopping carts on a cumulative basis. For example, if the range was set at between 3 to 4 items, then this sub-rule would be satisfied if the visitor puts a third item in the shopping cart. This is regardless of how long the visitor has been on the site or how many items have been viewed. A visitor can put 7 widgets in the shopping cart at one time but this would not satisfy the sub-rule. If they then proceed to take out 6 widgets and have one left in their shopping cart, this sub-rule would still not be satisfied. But if they then add 3 widgets for a total of 4, this rule would be satisfied. If the range were set at between 0 and 1, this sub-rule would be triggered on the homepage because the visitor would not have anything in their shopping cart unless it is carried over from a previous session.

The “Has a Shopping Cart Containing X to Y $ Value of Items” sub-rule, the marketing manager is able to target visitors based on how much value in dollars the visitor has in his/her shopping cart on a cumulative basis. For example, if the range was set at between 100 to 150, then the sub-rule would be satisfied if the visitor put a $100 item in his/her shopping cart regardless of how long the session has been or how many items have been viewed. If the visitor adds only one $151 item to an empty shopping cart, this sub-rule would not be satisfied.

The “Conducted Between X to Y Searches” sub-rule enables the marketing manager to target the visitor based on the number of product searches that have been conducted. This can be particularly effective by offering wavering visitors a proactive message such as an additional number to call. For example, if the range was set at between 10 to 11 searches, then once a visitor conducts their tenth search, the sub-rule would be satisfied and the action is made.

The “Left the Site After Having Added into Their Shopping Cart Between X to Y Items”sub-rule is effective in targeting visitors who were close to a buy in previous sessions, but ended up abandoning their cart. Note that the system times out a visitor and considers it a new session if it does not detect any activity from on the browser window within 3 hours. For example, if the range was set between 1 and 100, then to satisfy this sub-rule the visitor would have to add at least 1 and not more than 100 items, within the three hour session, into their shopping cart before a promotion would be triggered. Thus if the sub-rule is set between 1 to 100 and the visitor adds 3 items to their cart and then leaves for a four hour lunch, when they return and click on another page the promotion would be triggered.

The “Left the Site After Having Added into their Shopping Cart Between X to Y $ Value of Items” sub-rule is fundamentally the same as the “Left the Site After Having Added into Their Shopping Cart Between X to Y Items” sub-rule, however, the triggers are based on the quality of items instead of quantity of items, making this a dollar value trigger. Note that the system times out a visitor and considers it a new session if it does not detect any activity from the browser window within 3 hours. For example, if the range was set between 100 and 1000, then to satisfy this sub-rule the visitor would have to add at least 100 and not more than 1000 items (on a cumulative basis) before a promotion would appear. Thus if the sub-rule is set between 100 to 1000 and the visitor adds 300 items to their cart and then leaves for a four hour lunch, when they return from lunch and click on another page the promotion would be triggered.

The modeled rules 604 are based on real-time, Bayesian updating models that allow a manager to trigger a rule based on probabilities. Modeled Rules 604 are shown in FIGS. 6A and 6B, and include the following sub-rules. The “Probability of returning is between x and y%” sub-rule allows a manager to trigger a rule based on the probability that a visitor will return. For example, as a visitor is moving through the site, a promotion may be given only when the probability of returning is between 10 and 20%.

The “Estimated next return visit is between x and y days” sub-rule allows a manager to trigger a rule based on when the next return visit may be. For example, as a visitor is moving through the site, a promotion may be given only when the estimated next return visit is between 20-22 days.

The “Value to your company is between x and y dollars” sub-rule allows a manager to trigger a rule based on lifetime value of the customer. For example, as a visitor is moving through the site, a promotion may be given only when the lifetime value of the customer is between $2,000 and $2,200 dollars.

The “Estimated response to a promotion is between x and y%” sub-rule allows a manager to trigger a rule based on estimated promotional response. For example, as a visitor is moving through the site, a promotion may be given only when the estimated promotional response is between 75-80%.

The “Probability of purchasing is between x and y%” sub-rule allows a manager to trigger a rule based on the probability of purchasing. For example, as a visitor is moving through the site, a promotion may be given only when the probability of purchasing is between 30-40%.

The “Probability of exiting your website without purchasing is between x and y%” sub-rule allows a manager to trigger a rule based on the probability of exiting without purchasing. For example, as a visitor is moving through the site, a promotion may be given only when the probability of exiting the website without purchasing is between 80-85%. The “Probability of exiting is x% more likely than normal” sub-rule allows the manager to trigger a rule based on the probability of exiting more likely than normal. For example, a promotion may be given only when the probability of exiting the website is 10% more likely than normal.

The Bayesian models include a baseline purchasing model that can be applied across all sessions for a given visitor through a binomial buying equation:

P(x;n,p)=p^{x}(1−p)^{n-x}

or a beta heterogeneity equation:

$$f ( p ; a , b ) = \frac{1}{B ( a , b )} {{p}^{a - 1} ( 1 - p )}^{b - 1}$$

where p is the latent probability of purchasing, x represents the number of purchases, n represents the number of attempts to purchase, and a and b are shape parameters of the beta distribution and are constants, and:

$$P ( x ; a , b ) = \frac{B ( a + x , b + n - x )}{B ( a , b )}$$

The baseline purchasing model that may also be applied for each session, where the purchasing probability is calculated with beta-Bernoulli and Bayesian updating, as follows:

$$f ( {p}_{ij} ) = \frac{a + {x}_{l} ( j - 1 )}{a + b + {n}_{i} ( j - 1 )}$$

Covariate effects may be applied as well, and shift the expected purchasing probability by shifting the shape parameter of the beta distribution, as follows:

$$f ( {p}_{ij} ) = \frac{a exp \{ {c}_{ij} \cdot β \cdot {z1}_{ij} \} + {x}_{i ( j - 1 )}}{a exp \{ {c}_{ij} \cdot β \cdot {z1}_{ij} \} + b exp \{ {c}_{ij} \cdot γ \cdot {z2}_{ij} \} + {n}_{i ( j - 1 )}}$$

where cᵢⱼ indicates the cluster assignment for visitor i's j ^{th} session; z1ᵢⱼ is the vector of webpage covariates, β is a vector of webpage covariate effects, z2ᵢⱼ is the vector of threshold covariates, and γ is a vector of threshold covariate effects.

Each webpage has an effect on the purchasing probability for the session. Different types of webpages have different types of effects. Thus, the vector of webpage covariates z1ᵢⱼ may be a information webpages, search webpages, category webpages, product webpages, and brand webpages. Furthermore, the vector of threshold covariates z2ᵢⱼ may include session characteristics such as the amount of time spent on a webpage.

Consumer visiting may also be modeled as an exponential-gamma (EG) timing process. That is, each individual's intervisit time is assumed to be exponentially distributed as governed by a latent rate •ᵢ. A behavioral assumption is that consumers' underlying rates of visiting webpages continually and incrementally change from one visit to the next. As individuals adapt to and gain experience with a new retail webpage, they may return to the webpage at a more frequent rate, lest frequent rate, or perhaps at the same rate for the next visit. By assuming that each individual will update his/her latent rate, after each visit, a way to specify this updating process is as follows:

•_{i(j•1)}••_{y}•C

Where •ᵢⱼ is the rate associated with visitor i's j^{th} repeat visit, and c is a multiplier that will update this rate from one visit to the next. If the updating multiplier c equals one, then consumer visiting is considered to be unchanging, and the stationary exponential-gamma would remain in effect. But if updating multiplier c is greater than one, then consumers are visiting more frequently as they gain experience, and if updating multiplier c is less than one, then consumers are visiting less frequently as they gain experience.

Individual rates •ᵢ may also vary across the population. This heterogeneity can be captured by a gamma distribution with a shape parameter r and a scale parameter •. These distributions are given by the following two densities:

f(tᵢⱼ,•ᵢ)••ᵢe^{••i(t}ᵢⱼ•t_{i(j•1)})

$$g ( {•}_{i} ; r , • ) • \frac{{•}_{l}^{r • 1} {•}^{r} {e}^{{•••}_{i}}}{• ( r )}$$

where tᵢⱼ is the day when the j^{th} repeat visit occurred, and tₜ₀ is the day of their initial visit. For a single visit occasion, this leads to the following exponential gamma mixture model:

$$f ( {t}_{ij} ; r , • ) {•f}_{{•}_{0}} ( {t}_{ij} ; {•}_{i} ) •g ( {•}_{i} ; r , • ) d •• \frac{r}{•} {( \frac{•}{•• ( {t}_{ij} {•t}_{i ( j • 1 )}} )}^{r •1}$$

This moment-matching approximation, used in conjunction with the Bayesian updating, permits recovery of the updated gamma parameters that determine the rate of visit λᵢⱼ for individual i'S j^{th} repeat visit, as follows:

$$r ( i , j ) • \frac{[ r ( i , j • 1 ) •1 ] •s}{[ r ( i , j • 1 ) •2 ] • ( s •1 ) • [ r ( i , j •1 ) •1 ] •s}$$

$$• ( i , j ) • \frac{[ • ( i , j •1 ) {•t}_{ij} {•t}_{i ( j • 1 )} ] ••}{[ r ( i , j • 1 ) •2 ] • ( s •1 ) • [ r ( i , j •1 ) •1 ] •s}$$

where r(i, 1) and •(i, 1) are equal to the initial values of r and

Customized Rules 606 are shown in FIG. 6A and include the following sub-rules. The “Viewed pages on CATEGORY XXX y to y seconds” sub-rule allows the manager to trigger a rule based on a visitor who is visiting a certain category for a duration of time. For example, a promotion may be given only when the visitor is visiting the electronics category for 50-60 seconds.

The “Viewed pages on category XXX y to y pages” sub-rule allows the manager to trigger a rule based on a visitor who is visiting a certain category for a number of pages. For example, a promotion may be given only when the visitor has viewed 8-10 pages in the books category.

The “Leaving page with URL containing XXX y seconds after leaving” sub-rule allows the manager to trigger a rule based on a visitor who has left a certain URL for certain amount of time. For example, a promotion may be given only when the visitor has left yahoo.com for 10 seconds.

The “Referred from URL containing XXX” sub-rule allows the manager to trigger a rule based on where the visitor was referred. For example, a promotion may be given only when the visitor came from www.google.com.

The “Idle on page with URL containing XXX for y seconds” sub-rule allows the manager to trigger a rule based on how long a visitor has been on a specific page. For example, a promotion may be given only when the visitor has been on a specific URL for 10 seconds.

The “Cross Sell/Up Sell” sub-rules allow the manager to trigger a rule based on what the visitor has in their shopping cart or is currently viewing. For example, a cross-sell or up-sell can be offered to someone looking at a suit or just placed the suit in the shopping cart. The cross-sell may be a tie.

The invention will be further clarified by the following examples, which are intended to be purely exemplary of the invention.

### EXAMPLE 1

Two Standard Rules: “Been on Site for Between X to Y Seconds” AND “Viewed Between X to Y Pages”. For this example, suppose the parameters X and Y for the sub-rule “Been on Site for Between X to Y Seconds” are 10 and 30. That is, this sub-rule is only triggered if the visitor has been on the site at least 10 seconds but no more than 30 seconds. The sub-rule “Viewed Between X and Y Pages,” has parameters X and Y of 3 and 6. There are four possible paths the visitor can take. Two of these paths lead to a promotion, and the other two do not.

Path 1: The visitor views between 3 and 6 pages (say 4 pages) in less than 10 seconds and waits for the remaining time (say 4 seconds) without taking any action. In this case, the promotion will pop up to the visitor in 4 seconds from entering the 4^{th} page corresponding exactly with 10 seconds from the visitors entry into the web site.

Path 2: The visitor waits between 10 and 30 seconds (say 15 seconds) before clicking any pages. The visitor then starts viewing multiple pages. When the visitor reaches the 3^{rd} page view, the promotion will pop up immediately.

Path 3: The visitor views more than 6 pages in less than 10 seconds then waits. Although each sub-rule is triggered separately in this case, the visitor will never receive the promotion because both of the sub-rules were never met at the same time.

Path 4: The visitor waits more than 30 seconds prior to viewing 3 pages. In this case, the visitor will not receive a promotion because the sub-rules were not met at the same time.

From this example, the reader can understand the need for both the lower limit (X) and the upper limit (Y) for each sub-rule.

EXAMPLE 2

Targeting first time visitors who spend an extended amount of time viewing one product. For this example, one target sub-rule and one standard sub-rule are combined—the target sub-rule “Visited X to Y Times in the Past” and the standard sub-rule “Viewed a Given Product for More Than X to Y Seconds.” To target the first time visitor, one must choose the parameters X and Y to both be zero for this sub-rule. The visitor's propensity for viewing the same product for extended periods of time can be captured by setting the parameter X to a large value (say 120 seconds in this example). To display the promotion to the visitor who views the same product for more time than 120 seconds without bound, the Y parameter is left blank indicating this value to be infinite. This rule (containing 2 sub-rules) now targets first time visitors who view the same product for extended periods of time.

EXAMPLE 3

Suppose an e-commerce site has a system that allows registered users complete access, but this complete access entails a subscription fee. In order to obtain more subscriptions, the marketing manager may want to offer incentives to those unregistered visitors who show interest in this service. The marketing manager is able to target just those individuals. This will prevent “spamming” the entire visitor population. “Spam” is unsolicited e-mail on the Internet, which often has the negative effect of driving visitors away from your site. Thus one implements a rule to give promotions only to visitors who show the most interest. Furthermore, one may wish to not give the promotion to visitors who are already registered or have turned the promotion in the past.

The rule necessary contains three sub-rules all of which are target sub-rules. To target visitors who are possibly more interested in becoming registered users, use the target sub-rule “Visited X to Y Times in the Past.” Choose X to be a large number (10 in this example) and leave Y blank (infinite). The second sub-rule applied is, “Have Been Offered Same Promotion X to Y Times.” This allows one to give the promotion only to visitors a limited number of times. If the visitor does not register by the third time of receiving this promotion, assume he/she is not very likely to register, and so discontinue delivery to that visitor. To do this, the X and Y values of “Have Been Offered Same Promotion X to Y Times” are set to 0 and 3. Once the promotion has been redeemed, a rule must be created to prevent further promotions going to that individual. To accomplish this, use the sub-rule “Have Redeemed Same Promotion X to Y Times”. To exclude visitors who have redeemed this promotion, choose X and Y to both be zero in this example. This provides a rule to target frequent visitors only a few times and a rule to prevent the promotion from going out to registered users.

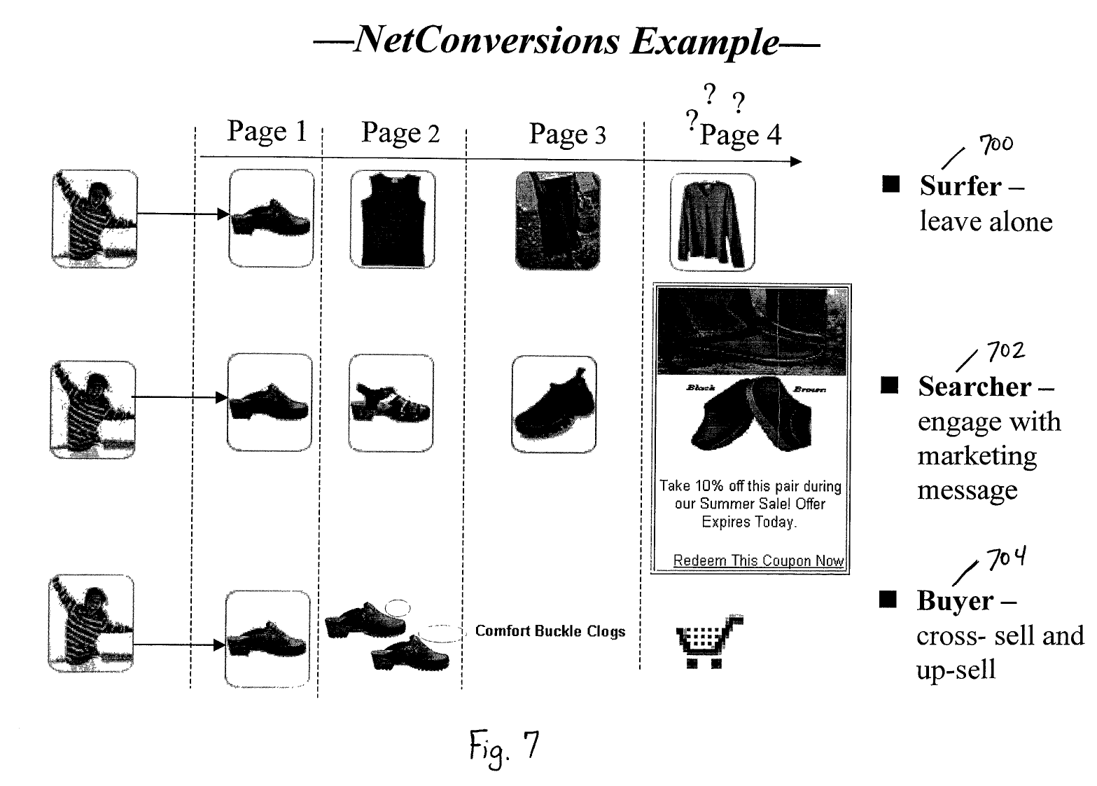

FIG. 7 is an example of how the system and method of the present invention may be applied given different visitor behavior types. If a visitor is moving through web server entity 106, the behavior models will detect certain shopping behavior and allow the business manager to react to behaviors in real-time. A first type of behavior may be a surfer 700 (in using the WWW, to surf is to either: explore a sequence of Web sites in a random, unplanned way; or use the Web to look for something in a questing way), so the intuition is to either leave him/her alone or to offer some service like live-chat. A second type of behavior may be a searcher 702, so it may make sense to offer some type of marketing message to engage the searcher to buy. A third type of behavior may be a buyer 704, so it doesn't make sense to offer a discount, perhaps offering some type of cross-sell or up-sell would make the most sense. The behavior models of the present invention are capable of distinguishing between behaviors. [This is done through monitoring their movements across categories/pages]

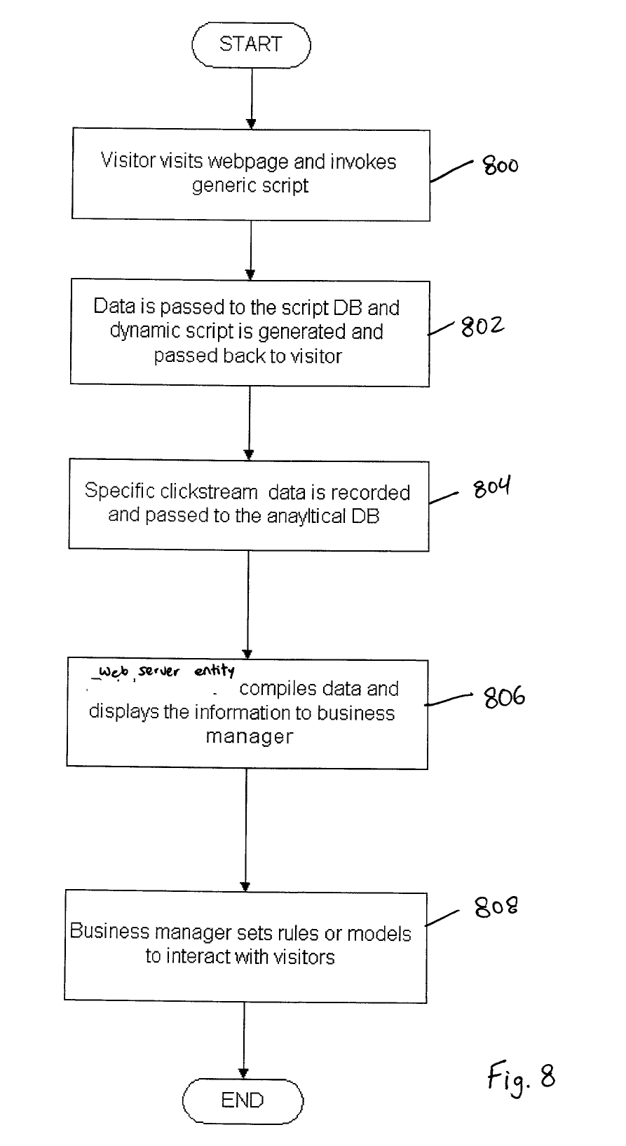

FIG. 8 is a flowchart of the major steps of a method for collecting visitor data points and information in accordance with the present invention. When a visitor visits a website on web server 106 and requests a webpage at step 800, a generic script is executed on the visitor client entity 104 at step 802. The executed script directs data to be sent to the script database 300 in which a dynamic script is passed back to the visitor client entity 104. The specific clickstream data that is captured by the dynamic script is recorded and sent to the analytical database 302, at step 804. Web server entity 106′ compiles data and displays the information per the business manager's request in real-time, at step 806. Based on the information, a business manager can create rules and set them in real-time to interact with the visitors at step 808. The process repeats itself with each hit to a web page of web server 106.

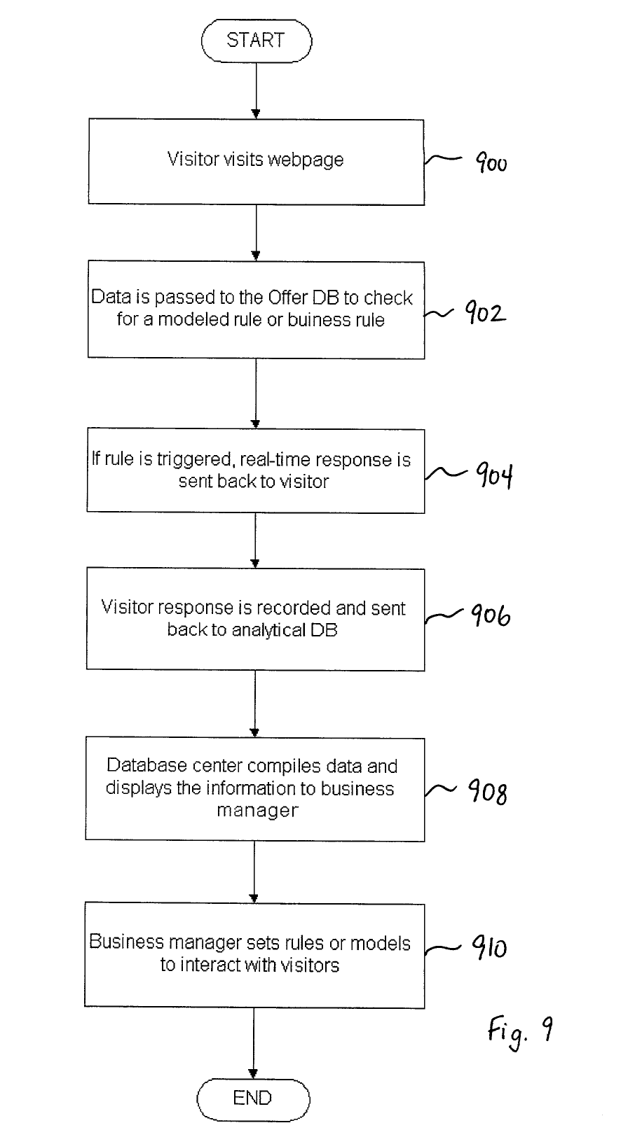

FIG. 9 is a flowchart of the major steps of a method for providing real-time response to the visitor and recording the results in accordance with the present invention. When a visitor visits a web page of web server 106, at step 900, data is passed to offer database 304 to check for a modeled rule or business rule that may be triggered (step 902). If a rule is triggered, a real-time response is sent directly to the visitor client entity 104 at step 904. At step 906, the visitor's response is recorded and sent back to analytical database 302 of web server 106′. At step 908, web server 106′ compiles the data regarding the response and displays the information to business manager client entity 104 in real-time per request. Based on the data displayed the manager may change, adjust, or create a new rule to interact with the visitor, at step 910.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for generating real-time promotions on a website to increase the likelihood of purchase on the website, the system comprising:
a memory configured to store instructions; and
a processor configured to execute instructions for:
receiving and storing clickstream data from a visitor to the website,
calculating the probability that the visitor will leave the website and the probability that the visitor will make a purchase on the website based upon the clickstream data,
utilizing the calculated probabilities, the frequency of visits to the website by the visitor, and the time of the visit to the website, to decide whether real-time promotions should be generated on the website, and
automatically calculating what promotions to send, when to send them, and how to send them, if real-time promotions are to be generated.

2. A system for generating real-time promotions on a website to increase the likelihood of purchase on the website as recited in claim 1, wherein the real-time promotions are delivered in a predetermined manner.

3. A system for generating real-time promotions on a website to increase the likelihood of purchase on the website as recited in claim 2, wherein the predetermined manner is selected from the group consisting of: electronic mail, interstitial, embedded, virtual call center, live text chat, facsimile, and live telephone call.

4. A computer-implemented method for generating real-time promotions on a website to increase the likelihood of purchase on the website, the method comprising the steps of:
receiving and storing clickstream data from a visitor to the website;
calculating the probability that the visitor will leave the website and the probability that the visitor will make a purchase on the website based upon the clickstream data;
utilizing the calculated probabilities, the frequency of visits to the website by the visitor, and the time of the visit to the website, to decide whether real-time promotions should be generated on the website; and
automatically calculating what promotions to send, when to send them, and how to send them, if real-time promotions are generated in the utilizing step.

5. A computer-implemented method for generating real-time promotions on a website to increase the likelihood of purchase on the website as recited in claim 4, wherein the real-time promotions are delivered in a predetermined manner.

6. A computer-implemented method for generating real-time promotions on a website to increase the likelihood of purchase on the website as recited in claim 5, wherein the predetermined manner is selected from the group consisting of electronic mail, interstitial, embedded, virtual call center, live text chat, facsimile, and live telephone call.

7. A computer readable medium that stores instructions executable by at least one processor to perform a method for generating real-time promotions on a website to increase the likelihood of purchase on the website, comprising:
instructions for receiving and storing clickstream data from a visitor to the website;
instructions for calculating the probability that the visitor will leave the website and the probability that the visitor will make a purchase on the website based upon the clickstream data;
instructions for utilizing the calculated probabilities, the frequency of visits to the website by the visitor, and the time of the visit to the website, to decide whether real-time promotions should be generated on the website; and
instructions for automatically calculating what promotions to send, when to send them, and how to send them, if real-time promotions are generated in the utilizing step.

8. A computer readable medium as recited in claim 7, wherein the real-time promotions are delivered in a predetermined manner.

9. A computer readable medium as recited in claim 8, wherein the predetermined manner is selected from the group consisting of: electronic mail, interstitial, embedded, virtual call center, live text chat, facsimile, and live telephone call.
